(19) United States
(12) Patent Application Publication
(10) Pub. No.: US 2007/0290801 A1
(43) Pub. Date: Dec. 20, 2007

(54) Coach and player sports communication system

(76) Inventor: Milton Powell, Kyle, TX (US)

Correspondence Address: Donald W. Meeker;Patent Agent, 924 East Ocean Front #E, Newport Beach, CA, 92661, US

(21) Appl. No.: 11/446,058

(22) Filed: Jun. 2, 2006

(51) Int. Cl. G08B 5/22

(52) U.S. Cl. 340/7.55; 340/7.21; 340/323 R; 340/7.63

(57) ABSTRACT

A portable, wireless, bi-directional communication system for transmitting visual information about plays and instant messaging between a coach and players during a game comprises a notebook or palm sized computer device with transmitter and receiver, and a wrist sweat band viewing screen with transmitted and receiver, thereby creating an effective, continual flow of information uninterrupted by the difficulty in hearing over a noisy crowd.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to body-worn communication systems and particularly to a wireless sports communication system comprising a wrist sweat band worn by a player having a receiving device and display therein and a notebook- or palm-sized computer device with a microphone and wireless transmitter used by the coach to transmit visual play information and instant text messages to the player, with which computer device the coach can select and send previously downloaded plays and instructions to a player, such as the quarterback or pass receiver or other players in a football game and speak into the device to transmit instant text messages.

2. Description of Related Art Including Information Disclosed Under 37 CFR 1.97 and 1.98

Typically, within a football game the coach of a football team wears a headset so that he can communicate by radio to a receiver located in the quarterback's helmet. This communication is for the purpose of making changes in the defensive or offensive systems of the football team or selecting plays. When a crowd is too noisy this system is not effective. Prior art systems do not adequately address the problem of continual effective communication between a coach and quarterback throughout a game and do not address the problem of communication between a coach and other players such as a pass receiver.

U.S. Patent application #20040102931, published May 27, 2004 by Ellis, describes a modular personal network (MPN) that includes multiple devices that may be worn, carried, or used in close proximity to a user. The devices communicate wirelessly. Functions of the MPN may be modified by adding or removing components. The MPN may communicate with a personal computer. General purpose devices may include a control unit, a display, a user input, and an audio output. The MPN may provide a variety of functions, including time, communication, entertainment, organization, guidance, athletic, medical, travel, outdoors, identity, security, and military.

U.S. Patent Application #20040215958, published Oct. 28, 2004 by Ellis, discloses modular personal networks (MPNs) that include multiple devices that may be worn, carried, or used in close proximity to a user. The devices communicate wirelessly. Devices include security circuitry that prevents them from being used in a different MPN once the user has configured them. Devices not designed for use within an MPN can be included in the network using a bridge device. Devices can be integrated into items of jewelry, such as earrings, rings, pendants, and bracelets. One item of jewelry, such as a bracelet, can support multiple replaceable modules with variable functions. Functions of the MPN can include communications, entertainment, medical monitoring, sports monitoring, personal organization, and games. Multiple users each with his or her own MPN can use them to collaborate in creation of music. An MPN can be used for mobile recognition and logging of wildlife.

U.S. Pat. No. 4,536,739, issued Aug. 20, 1985 to Nobuta, indicates an apparatus for communication of instructing information comprises a transmitter, a receiver and a data setting portion. A random access memory of the transmitter is in advance stored with a plurality of pieces of instructing data and any one of the pieces of instructing data, as stored, is read out and is displayed by a display. Any one of the pieces of instructing data is selected by a selection key and the address data corresponding to the instructing data as selected is transmitted by the transmitter. On the other hand, the receiver receives the transmitted address data. The receiver is provided with a random access memory for storing the instructing data as is similar to that of the transmitter. The corresponding instructing data is read from the random access memory as a function of the received address data and the instructing information is reproduced as a speech sound by means of a speech synthesizing circuit. The instructing data stored in the random access memory of the transmitter and the random access memory of the receiver is arbitrarily changed by means of the data setting portion.

U.S. Pat. No. 4,879,651, issued Nov. 7, 1989 to Little, claims a wrist carried microcomputer worn on an athletic wristband by a player for recording information based on a won-lost outcome with a limited ability to track the type of a shot resulting in the outcome. The device is limited to single player and not usable in a team sport activity.

U.S. Pat. No. 6,330,961, issued Dec. 18, 2001 to Borja, provides an elongated pouch with various storage pockets for storage of personal articles therein, which is mounted upon a forearm of a user of the pouch such as the driver of an automobile. A personnel communicator device is positioned within the pouch, the personnel communicator device having a data transmission portion, typically a keyboard and a character display screen, facing the driver of the vehicle for facilitating data exchange between the driver and the personnel communicator device while operating the vehicle. The screen generated characters are displayed along a line parallel to the length of the forearm of the driver of the vehicle to facilitate easy reading of the characters by the driver of the vehicle.

U.S. Pat. No. 2,904,645, issued Sep. 15, 1959 to Sarles, is for a football helmet containing a receiver, headphones, and other necessary components. The patent also provides for the installation of the device in various other types of helmets, such as construction helmets, and the like. No transmitting means is disclosed, however.

U.S. Pat. No. 5,142,700, issued Aug. 25, 1992 to Reed, shows a protective helmet, such as a football helmet, motorcycle helmet, construction helmet, or the like that comprises a shell made of impact-resistant material. Inside of the helmet is a complete transceiver system which allows two-way wireless communication between persons in the same location or to a remote base unit. No components of the system protrude from either the interior or exterior of the helmet shell as the antenna follows the configuration of the shell centerline while one or more microphones are contained within elements of the face guard. A switch device, also contained within the face guard and including an illuminated element, is disposed within the field of view of the wearer.

U.S. Pat. No. 4,885,797, issued Dec. 5, 1989 to Leather, discloses a communication system for instructing individual members of a group and the group as a whole comprising a transmitter to be used by the instructor and a receiver for each member of the group which receiver contains an electric battery and is mounted on an elastically extensible article to be worn on the head of the respective member, each receiver designed to be extensible and to be contained within the extensible article, an input amplifier stabilized by a crystal oscillator and yielding an audio frequency signal, decoding means for sensing a sub-audible tone in that signal identifying that the signal is intended for the entire group or another sub-audible tone identifying that the signal is intended for the particular receiver, an output circuit for passing the signal to audio transducers, one over each ear of the member in use, when the decoding means yields a signal denoting that a sub-audible tone acceptable to that receiver is contained in the audio frequency signal, and in that the transmitter injects a sub-audible continuous tone under the control of the instructor to identify the member to be instructed onto the audio input to the receiver. An alternate embodiment shows the receiving unit in a sweat band for foot sports with the receiving unit being in one or two parts.

U.S. Patent Application #20050049080, published Mar. 3, 2005 by Hovington, provides a communication system for soccer coaches and their staff that enables them to provide training from a distance and in noisy environments to soccer players anywhere on the training field without interruption. Each player wears an elastic bellyband around the waist. The bellyband has a center pocket that houses a radio receiver that is connected to a custom ear mold.

U.S. Patent Application #20050170870, published Aug. 4, 2005 by Goldenberg, shows a communication system for use in sports training or during play, wherein a first user can communicate on a real time basis with at least one second user, wherein the system includes at least one digital transmitter module for readily facilitating transferring a verbal message from a first user to at least one second user, and at least one digital receiving module for readily facilitating the second user receiving the verbal message from the first user. Preferably, the transmitter is used by the first user, such as a trainer, for real time communication with at least one second user, such as a player during a game, via a receiving device worn by the player. Optionally, the system includes a multi-user activator for transmitting to more than one user.

U.S. Patent Application #20050212202, published Sep. 29, 2005 by Meyer, claims a telepath sports training system of communication for providing instruction, information, and verbal commands between a teacher and a student. An exemplary embodiment of the invention is particularly suited for use between a sports coach and the players on his or her team. The system of the present invention is preferably comprised of a microphone for the coach, a transmitter, at least one receiver, and at least one speaker for at least one player.

What is needed is a system that is not interrupted by noise for continual effective communication between a coach and quarterback throughout a game and system for communication between a coach and other players such as a pass receiver.

### BRIEF SUMMARY OF THE INVENTION

An object of the present invention is to provide a wireless, lightweight sports communication system comprising a wrist sweat band viewing screen worn by a player having a receiving device and display therein and a notebook- or palm-sized computer device including a microphone to generate instant text messages, and a wireless transmitter used by the coach to transmit visual play indications and text messages to the player, with which computer device the coach can select and send previously downloaded plays and instructions and speak to create instant text messages to send to a player, such as the quarterback or pass receiver or defensive players in a football game, thereby creating a system for continual effective communication between a coach and quarterback throughout a game regardless of the noise level of the crowd and a system for communication between a coach and other players such as a pass receiver.

In brief, the present invention provides a portable, wireless, bi-directional communication system for transmitting visual information such as pre-recorded plays and verbally created instant text messages between a coach and players during a game, thereby creating an effective, continual flow of information unimpeded by the difficulty of hearing over a noisy crowd.

An advantage of the present invention is that it provides a system for continual effective communication between a coach and quarterback throughout a game and system for communication between a coach and other players such as a pass receiver, regardless of the noise level of the crowd.

Another advantage of the present invention is that it provides a visual system of communication between the coach and players that doesn't require them to be able to constantly see one another.

One more advantage of the present invention is that it provides an instant text messaging capability in case a play needs clarification or to send other play information not previously stored.

An additional advantage of the present invention is that it allows for an unlimited number of plays to be communicated between the coach and players.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a diagrammatic plan view of a play selecting and transmitting computer device with a visual screen and microphone used by a coach and a play receiving sweat band viewing screen worn by a player on the playing field;

FIG. 2 is a diagrammatic plan view of a play receiving sweat band viewing screen worn by a player on the playing field.

### DETAILED DESCRIPTION OF THE INVENTION

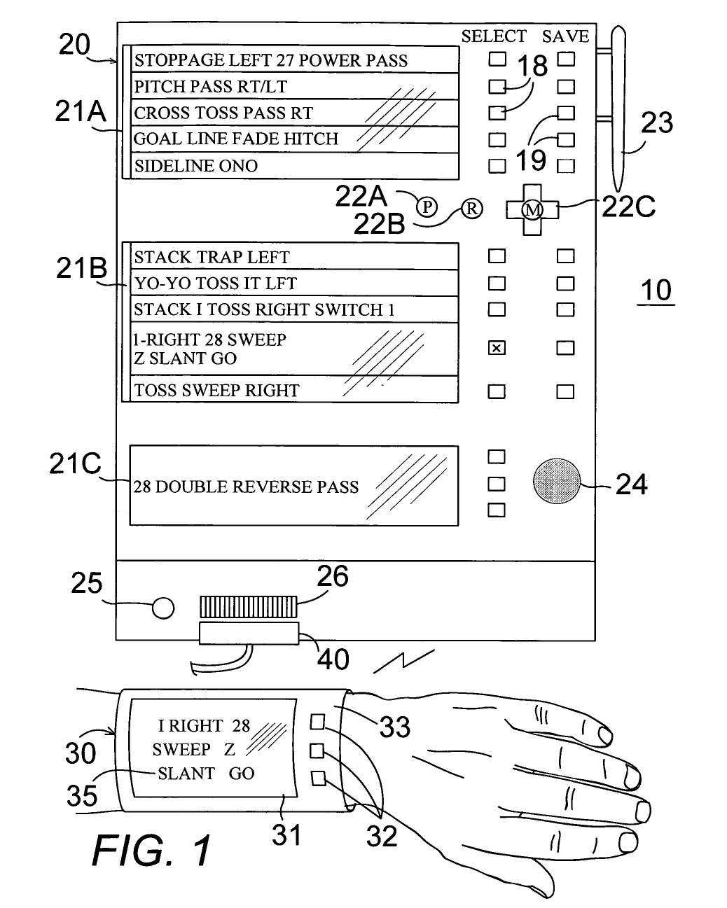

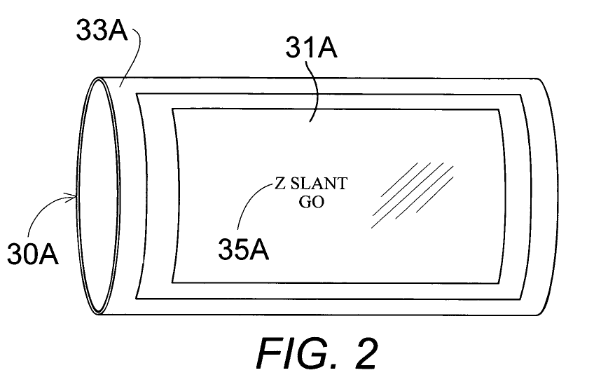

In FIGS. 1 and 2, a wireless sports communication system 10 comprises a play selecting and play transmitting notebook- or palm-size computer device 20 used by a coach to send recorded plays to players and a play receiving wrist sweat band viewing screen 30, 30A worn by a player on the playing field and a supplemental microphone 24 on the computer device used by the coach for sending instant text messages to players.

In FIG. 1, a notebook or palm-sized computer device 20 with a wireless transmitter is used by a coach to transmit visual signals to the viewing screen 31 worn by the player. The computer device 20 operates on a rechargeable battery that holds a 24-hour charge and can be recharged using an AC adapter plugged into the AC port 25. The device connects to a personal computer or other input source by plugging the end 40 of a standard USB or FireWire cable into the USB or FireWire port 26 on the device. A pre-determined list of plays can be downloaded from the personal computer or other input source onto the computer device of the present invention prior to the game.

The computer device 20 has at least one computer screen. In a preferred embodiment, as shown in FIG. 1, three separate, preferably touch-sensitive screens 21A, 21B, 21C, display three sets of previously programmed plays: passing plays on 21A, running plays on 21B, and mixed plays on 21C. The device also has a means, such as a stylus 23, for inputting information directly into the computer device. The user can write with the stylus directly onto the touch-sensitive screen to input play information not already downloaded from another source. The stylus is used to select plays to send to the player or to save plays for use later in the game by touching either the select button 18, or the save button 19 next to the individual plays displayed on the screens. The stylus is also used to choose the kind of plays displayed on the screens by pressing the pass button 22A, the run button 22B, or the mixed play button 22C.

The computer device 20 is used by the coach to select and send previously downloaded plays and instructions and currently input instructions to the players for the players to use on the playing field.

The computer device 20 has a microphone 24 used by the coach to send instant text messages to the players using wireless technology such as Bluetooth™.

In FIG. 1, a wrist sweat band viewing screen 30 is worn by a player participating in a sporting event on a playing field, such as a quarterback on the field in a football game. The wrist sweat band viewing screen comprises a band 33 encircling the wrist and forearm area of an arm of the player, a means of securing the band to the player, preferably a hook and loop-type fastener such as VELCRO® or other connecting means such as a buckle or snaps, an elasticized band, or taped to the wrist and forearm, a viewing screen 31 on an outer surface of the wrist band viewing screen for displaying visual indicia 35 indicating particular plays to be made in the game being played and instant text messages, a means for receiving wireless signals containing play information and a means for transmitting the received play information on the viewing screen. The wrist sweat band viewing screen also has a series of buttons 32 comprising a means for a player to respond to information received on the viewing screen including for the player to delete the plays from the viewing screen 31. The plays are received by the wrist sweat band viewing screen 30 via wireless transmission from the coach's computer device 20 and are displayed on the viewing screen 31 for 15 seconds unless the player deletes the plays from the viewing screen by touching the delete buttons 32.

In FIG. 2, a second wrist sweat band viewing screen 30A is worn by a player, such as a pass receiving player, an offensive player, a defensive player, or a special team player on a football playing field. The second wrist sweat band viewing screen comprises a band 33A encircling the wrist and forearm area of an arm of the player, a means of securing the band to the player, preferably a hook and loop-type fastener such as VELCRO® or other connecting means such as a buckle or snaps or taped to the wrist and forearm, a viewing screen 31A on an outer surface of the wrist band viewing screen for displaying visual indicia 35A indicating particular plays to be made in the game being played and instant text messages, a means for receiving wireless signals containing play information and a means for transmitting the received play information on the viewing screen. The plays are received by the wrist sweat band viewing screen 30A via wireless transmission from the coach's computer device 20 and are displayed on the viewing screen 31A for 15 seconds.

In use, a coach programs a list of potential plays to be used in a game and downloads them via a computer cable from computer or other input source onto the computer device of the present invention. The coach uses a stylus to select any of a number of plays from the screens on the computer device, or to input other plays by writing on the touch-sensitive screens. When the desired play is on the screen, the coach presses either the select button next to the play to send the play to the viewing screen on the wrist sweat band viewing screen device worn by the player, or presses the save button to save the play in memory for later use. The coach may access a list of pass plays, run plays, or mixed plays, by using the stylus to press the corresponding pass, run, and mixed play buttons on the computer device. The player receives the transmitted plays on his wrist band viewing screen, and, in the case of a quarterback, may press the buttons on the band to delete the plays from the viewing screen, making way for the transmission of more plays. If he does not press the delete buttons, the plays will automatically be deleted from the screen in 15 second intervals. The coach also uses a microphone device connected wirelessly to the computer device to create instant text messages for the player(s) to supplement the downloaded play information sent to the viewing screen.

It is understood that the preceding description is given merely by way of illustration and not in limitation of the invention and that various modifications may be made thereto without departing from the spirit of the invention as claimed.

What is claimed is:

1. A wireless sports communication system comprising:
a wrist sweat band viewing screen worn by a player participating in a sporting event on a playing field, the wrist sweat band viewing screen comprising a band encircling a wrist and forearm area of an arm of the player, a means of securing the band to the player, a viewing screen on an outer surface of the wrist band viewing screen for displaying visual indicia indicating particular plays to be made in the game being played and displaying instant text messages, a means for receiving wireless signals containing play information and a means for transmitting the received play information on the viewing screen;
a hand held computer device and wireless transmitter used by a coach to transmit visual signals to the viewing screen worn by the player, the computer device comprising at least one computer screen and means for inputting information to the computer screen, a means for selecting information on the computer screen, a means for writing visual information on the computer screen, a speaker means of transmitting voice inputs to the computer device to create instant text messages on the viewing screen, a means for downloading play information into the computer device from another computer or input device, and a means for transmitting wireless signals from the computer device to the viewing screen worn by the player, the computer device used by the coach to select and send previously downloaded plays and instructions and send instantly input visual and instant text messages instructions to the player for the player to use on the playing field.

2. The system of claim 1 wherein the wrist sweat band viewing screen further comprises a means for a player to respond to information received on the viewing screen.

3. The system of claim 1 wherein the wrist pad viewing screen is worn by a quarterback on a football playing field.

4. The system of claim 1 wherein the wrist pad viewing screen is worn by a pass receiving player on a football playing field.

5. The system of claim 1 wherein the wrist pad viewing screen is worn by an offensive player on a football playing field.

6. The system of claim 1 wherein the wrist pad viewing screen is worn by a defensive player on a football playing field.

7. The system of claim 1 wherein the wrist pad viewing screen is worn by a special team player on a football playing field.
